(19) United States
(12) Patent Application Publication
(10) Pub. No.: US 2001/0004051 A1
(43) Pub. Date: Jun. 21, 2001

(54) Water-processing domestic appliance with assembly for de-ionizing water

(75) Inventors: Godwin D. Zwanenburg, Hoogeveen (NL); Hai L. Ge, Singapore (SG); Yue Fang, Singapore (SG)

Correspondence Address: Michael E. Marion, Corporate Patent Counsel, U.S. Philips Corporation, 580 White Plains Road, Tarrytown, NY, 10591, US

(73) Assignee: U.S. PHILIPS CORPORATION

(21) Appl. No.: 09/738,993

(22) Filed: Dec. 14, 2000

(30) Foreign Application Priority Data
Dec. 17, 1999 (SG) 9906415.6

(51) Int. Cl. B01D 61/46; B01D 35/06; C25B 9/10; C25B 11/04

(52) U.S. Cl. 204/633

(57) ABSTRACT

A water-processing domestic appliance with means (410; 620) for processing water and, upstream of said means, a cathode (35) and an anode (45) for the de-ionization of water in a de-ionization space (50) before said water is processed. A cathode screen (31) screens off a cathode region (30) from the de-ionization space (50), said cathode (35) being situated in the cathode region (30), while at least a portion of the cathode screen (31) is formed by a kation membrane (32). A much reduced maintenance necessity is achieved in that ions can be removed from the water to be processed without necessarily depositing on the cathode, and can be removed from the cathode region together with liquid.

The invention relates to a water-processing domestic appliance as defined in the preamble of claim 1.

Such appliances are known from daily practice in the form of steam irons. When so-called hard water, i.e. water with a comparatively high content of, for example, calcium and magnesium ions, is used in these appliances, problems will arise because these substances will deposit in the form of insoluble salts on components such as heater elements. This deposition leads to an impaired effectivity of or damage to the appliance.

The use of previously electrochemically de-ionized water in the appliance reduces the concentration of calcium and magnesium in the water, whereby the detrimental deposit can be prevented or at least counteracted. For this purpose, two electrodes are used in the water container system of the appliance, such that the substances which are to be removed and which are dissolved in the water are deposited on the electrodes owing to the application of a voltage difference between the electrodes.

It is a disadvantage of such known appliances that they require a considerable amount of maintenance. The electrodes have to be cleaned or regenerated because their effectivity is reduced in the course of time by the deposition of salts such as calcium and magnesium salts. This is particularly disadvantageous in the case of domestic appliances, which are usually not maintained in accordance with regular maintenance schedules. The decreasing de-ionizing action adversely affects the useful life of the appliances. Moreover, expensive constructions are often necessary for rendering maintenance possible.

It is an object of the invention to provide a solution to the problem of the de-ionization of water in a domestic appliance which requires less maintenance and where a periodic replacement of components saturated with deposited salts is not necessary.

The invention for this purpose provides an appliance as claimed in claim 1.

The de-ionization of the water can be carried out here in that ions are made to pass through the membrane, which is subsequently removed from the de-ionization region without the necessity of having the ions deposit on the electrode.

The ions are drawn from the water under treatment through the membrane under the influence of the voltage difference applied between the electrodes, and they are thus removed from the water under treatment. The ion concentration in the treated water which is to be processed is thus reduced, so that the generation of deposits during the use of the water is counteracted.

The invention will be explained in more detail below in a detailed description of embodiments with reference to the drawing, in which

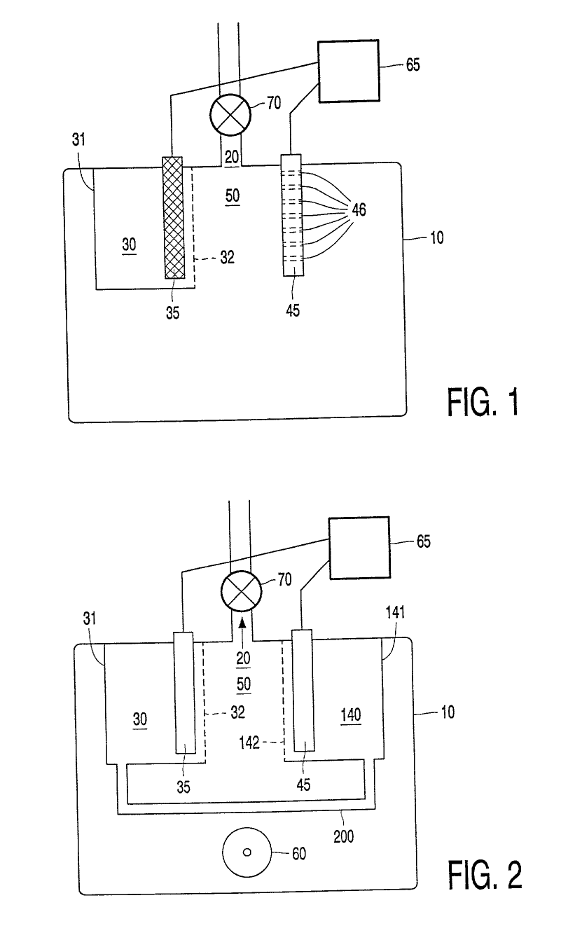

FIG. 1 is a diagrammatic cross-sectional view of a first embodiment of a de-ionization assembly in an appliance according to the invention,

FIG. 2 is a diagrammatic cross-sectional view of a second embodiment of a de-ionization assembly in an appliance according to the invention,

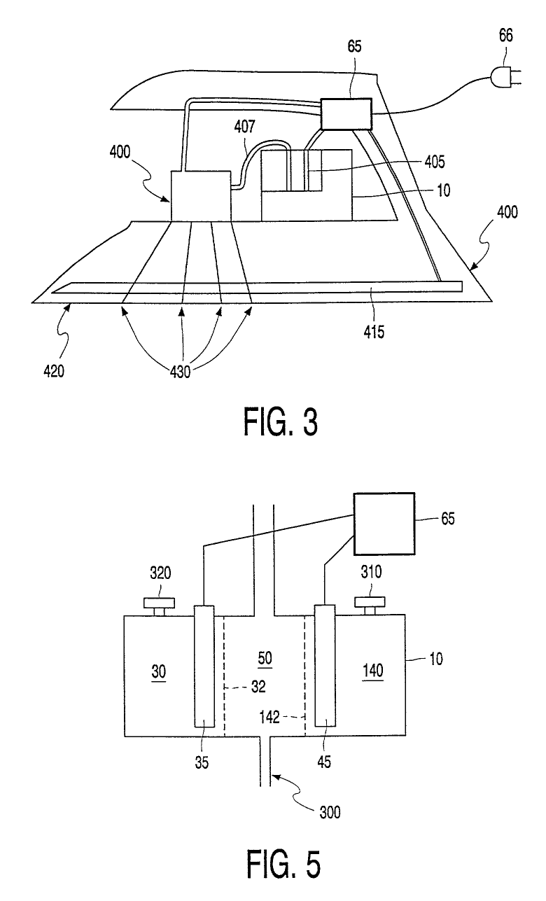

FIG. 3 shows an appliance according to the invention in the form of an electric steam iron,

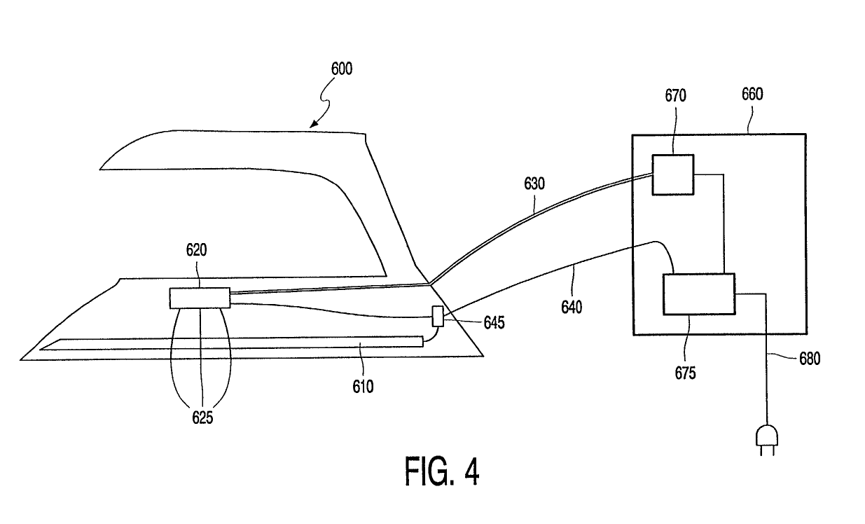

FIG. 4 shows an appliance according to the invention in the form of an ironing system, and

FIG. 5 is a diagrammatic cross-sectional view of a third embodiment of a de-ionization assembly in an appliance according to the invention.

FIG. 1 shows a de-ionization assembly 1 of an appliance according to the invention. This de-ionization assembly 1 comprises a reservoir 10 for holding water, which reservoir may be accommodated, for example, in an electric iron. A delivery passage 20 merges into the reservoir 10. A pump 70 is mounted in the delivery passage for pumping water from the reservoir 10 to a steam-generating heater element of the electric iron and/or to spray nozzles of the electric iron.

A cathode 35 and an anode 45 are situated adjacent this delivery passage 20. The cathode 35 and the anode 45 are situated at such a distance from one another that de-ionization of water present in a space 50 between the cathode 35 and the anode 45 can take place when a voltage difference is applied between the cathode 35 and the anode 45.

The cathode 35 is present in a space 30. This space 30 is separated in a substantially watertight manner from the space of the reservoir 10 by a wall 31. Part of the wall 31 facing towards the anode 45 and adjoining the de-ionization space 50 is constructed as a kation membrane 32. Such a membrane is commercially available, for example under the brand name Nafion from the Du Pont company, and has the property that it allows kations such as, for example, Ca²⁺and Mg²⁺to pass, but forms a barrier to other particles such as, for example, water molecules.

The cathode 35 is connected to a DC voltage source 65. The cathode 35 in this example is manufactured from stainless steel gauze. The space 30 contains water, which is a suitable medium for transporting and dissolving ions.

The anode 45 is manufactured from a graphite plate provided with holes 46. Alternatively, for example, a titanium gauze with a platinum coating may be used; however, the graphite used in the example has the advantage that it is less expensive. The electrode 45 is also connected to the voltage source 65. Since the cathode 35 and the anode 45 are situated opposite one another, they define the de-ionization space 50 between the membrane 32 and the anode 45, where the water present can be treated. The spacing between the membrane 32 and the anode 45 preferably lies in a range from 0 to 2 cm.

During operation the reservoir 10 is filled with common tap water. The space 30 is also filled with water. Water can now be transported from the reservoir 10 through the delivery passage 20, during which the water is conducted through the de-ionization space 50. Furthermore, a constant voltage difference is maintained between the cathode 35 and the anode 45. Preferably, this voltage difference lies in a range from 35 to 42.5 volts, whereby a satisfactory de-ionization is obtained, without the voltages used forming a hazard to the user and accordingly necessitating special safety measures. A substantial portion of the Ca²⁺and Mg²⁺ions is drawn from the water passing through the de-ionization space 50 through the kation membrane 32 by this voltage difference. As a result, the water leaving the reservoir 10 has been divested to a substantial extent of undesirable ions. The removed ions are present in the space 30, where they remain substantially dissolved, but where they may possibly also be deposited. When the water in the reservoir 10 has been entirely used up, the water in the cathode space 30 with the ions dissolved therein may be easily drained from the space 30 before the reservoir 10 is filled again. Then both the reservoir 10 and the space 30 are filled with water again, and the appliance is ready for use once more. The renewal of the water in the space 30 can thus always be combined in a simple manner with the filling-up of the reservoir for the main quantity of water to be processed. This is true not only for electric irons, but also for other domestic appliances which generally suffer from scale deposits such as coffeemakers, water kettles, steam generators, and other water-heating equipment, as well as, atomizers which are to be filled up regularly with a comparatively limited quantity of water to be used. During the renewal of the water in the space 30, the ions removed from the water to be used but not deposited on the electrode are discharged each time in a very simple manner.

A second embodiment of a de-ionization assembly is shown in FIG. 2. This de-ionization assembly is similar to the de-ionization assembly in the first example as regards the reservoir 10 and the arrangement of the cathode 35. These corresponding components are accordingly not discussed in detail. The anode 45 in the de-ionization assembly according to this embodiment is provided in an anode space 140. The anode space 140 is entirely or substantially water tightly separated from the main space of reservoir 10 by a wall 141. A portion of the wall 141 facing towards the cathode 35 and adjoining the de-ionization space 50 is constructed as an anion membrane 142. Such a membrane is commercially available, for example under the type designation ESC-7001 from Electrosynthesis Co. Inc. (USA), and has the property that it allows anions to pass but forms a barrier for other particles such as, for example, water molecules. The interspacing between the membranes 32 and 142 is 0.5 cm.

The cathode 35 is situated closely against the kation membrane 32, and the anode 45 closely against the anion membrane 142. Preferably, the space between the anion membrane 142 and the kation membrane 32 is smaller than the space between the anode 45 and the anion membrane 142, and the space between the anion membrane 142 and the kation membrane 32 is smaller than the space between the cathode 35 and the kation membrane 142.

A circulation pump 60 is present in the reservoir for the purpose of agitating the water present in the reservoir 10. The effectivity of the de-ionization process is improved by this agitation.

During operation, as in the first embodiment, a constant voltage difference is maintained between the cathode 35 and the anode 45. Preferably, this voltage difference again lies in a range from 35 to 42.5 volts, whereby a good de-ionization is obtained without the voltages posing any hazard. Subsequently, water passing through the space 50 is freed from kations in a similar manner to the one described above. In addition, anions are drawn through the membrane 142 in the space 50, so that they end up in the space 140 and have thus been removed from the water to be used. It is prevented thereby that the acidity of the water is increased.

A channel 200 runs between the cathode space 30 and the anode space 140. This channel 200 interconnects these spaces 30 and 140. During use, the water in the space 140 becomes acidic, and the water in the space 30 becomes alkaline because the anions and kations from the treated water are collected in the spaces 140 and 30, respectively. This may lead to a very high or low acidity, as applicable, which again may lead to corrosion of the device. The spaces 30 and 140 communicate with one another through the channel 200, so that the contents of the two spaces 30 and 140 neutralize each other. The channel 200 is constructed as a hollow tube which during use runs below the liquid level in the spaces 30, 140, so that the channel 200 during use forms a water interconnection between these spaces 30, 140.

FIG. 3 shows an appliance according to the invention in the form of an electric iron 400 which is provided with a reservoir 10 with a de-ionization assembly 405. The voltage required for the operation is supplied by a voltage control unit 65 which in the operational state is connected to the mains through a connection in the form of a cord and plug 66. The voltage control unit controls the voltage required for each component. The de-ionization assembly is in communication with a heater unit 410 through a channel 407. The heater unit 410 is supplied from the voltage source 65 and converts the de-ionized water into steam, which is passed through a number of channels 430 to a sole 420. The electric iron 400 is provided with a heater element 415 near its sole 420 for heating the sole 420. The heater element 415 is connected to the voltage control unit 65.

During operation, the reservoir 10 is filled with water. Then the voltage control unit 65 is put into operation in that it is connected to the mains. The heater element 415 is supplied thereby, as are the heater unit 410 and the de-ionization assembly 405. During a heating-up period necessary for allowing the heater element 415 and the heating unit 410 to reach their operational temperatures, the de-ionization of the water present in the de-ionization space 50 takes place in the de-ionization assembly 405. When the components to be heated have reached their operational temperatures, the water in the de-ionization space 50 has become sufficiently freed from ions so as to be ready for use. De-ionized water is drawn from the reservoir 10 then when the iron is operated for supplying steam. Between the actions of generating consecutive steam jets, a pause occurs each time in practice during which the actual ironing takes place. These pauses can again be utilized for the de-ionization of water in the de-ionization space. Thanks to the heating-up periods and the pauses between consecutive steam jets, there is thus always an opportunity for de-ionizing water before it is supplied to the heater element 10 for the generation of steam. It is also possible to de-ionize the water while it is flowing from the de-ionization region 50 in the operational state.

De-ionized water is available right from the start of operations without extra time loss or added operations preceding the use of such domestic appliances with heater elements or other water-processing members which require some time for achieving the operational state after being switched on.

The invention is particularly suitable for use in an ironing system as pictured in FIG. 4. This system comprises a steam iron 600 with an electric heater element 610 for heating the sole and a steam unit 620 for generating steam which is conducted through channels 625 in the sole region to the exterior. The system further comprises a base station 660 with a de-ionization unit 670 as described above. The base station 660 is further provided with a voltage control unit 675 which can be connected to the mains via a connection line 680. The voltage control unit 675 supplies the power required for the de-ionization unit 670, for the heater element 610, and for the steam unit 620. The de-ionization unit 620 is connected to the steam unit 620 in the iron 600 via a water duct 630. The iron 600 is connected to the voltage control unit 675 of the base station via an electric connection line 640 and a voltage controller 645.

During operation, the base station 660 is connected to the mains by means of the connection line 680. The voltage control unit 675 then supplies the de-ionization unit 670 and the heater units 610, 620. During heating-up to the operational temperatures of the heater units 610, 620, a first quantity of water is de-ionized in a manner as described in the example above. When the operational state has been reached, water can be supplied as desired from the de-ionization unit 670 to the steam unit 620, which water is de-ionized during its transport. The steam unit 620 generates steam from the water supplied through the duct 630 during operation and supplies it to the exterior through the channels 625 present in the sole.

This embodiment has the advantage that the electric iron itself can be of a lightweight design; it is also possible for the water quantity in the base station to be large without any adverse effects on the ease of handling of the electric iron. This in its turn renders it possible to produce steam for a long time without the water reservoir having to be filled up.

FIG. 5 shows an alternative embodiment of the invention in which the de-ionization space 50 is accommodated in a transport channel 300 for water. The cathode space 30 has a closable fill opening 320, through which opening 320 water can be introduced into the space 30. The anode space 140 is also provided with a closable fill opening 310. The channel 300 is connected to a water reservoir at the upstream side of the de-ionization space 50 and to a delivery channel at the downstream side. As in the previous example, a de-ionization space 50 is bounded by two membranes 32 and 142. As in the previous example, the voltage source 65 maintains a constant voltage difference between the anode 45 and the cathode 35 during operation, so that the water flowing through the space 50 is divested of ions. When the water present in the spaces 30 and 140 has become saturated with ions, and preferably a little earlier, the water with the ions removed from the de-ionization space 50 can be readily discharged through the respective fill openings 320 and 310 and be replaced with fresh water.

It will be obvious from the above to those skilled in the art that the invention is by no means limited to the embodiments and applications described here by way of examples.

1. A water-processing domestic appliance comprising means (410; 620) for processing water and, upstream of said means, a cathode (35) and an anode (45) for the de-ionization of water to be processed in a de-ionization space (50), characterized by a cathode screen (31) which screens off a cathode region (30) from said de-ionization space (50), said cathode (35) being situated in said cathode region (30), while at least a portion of the cathode screen (31) is formed by a kation membrane (32).

2. An appliance as claimed in claim 1, further comprising an anode screen (141) which screens off an anode region (140) from said de-ionization space (50), the anode (45) being situated in said anode region (140), while at least a portion of the anode screen (141) is formed by an anion membrane (142).

3. An appliance as claimed in claim 2, characterized by a channel (200) through which said cathode region (30) is in communication with said anode region (140).

4. An appliance as claimed in any one of the preceding claims, characterized by an opening (320) which is in communication with said cathode region (30) for the refreshment of a medium for dissolving ions in said cathode region (30).

5. An appliance as claimed in any one of the claims 2 to 4, characterized by an opening (310) which is in communication with said anode region (140) for the refreshment of a medium for dissolving ions in said anode region (140).

6. An appliance as claimed in any one of the preceding claims, further comprising a delivery passage (20, 300) for delivering water, said de-ionization space (50) being situated in or upstream of said delivery passage (20, 300).

7. An appliance as claimed in any one of the claims 2 to 6, further comprising a water reservoir in which said cathode region (30) and said anode region (140) are situated, while agitation means (60) are arranged in said water reservoir (10) for the purpose of agitating water.

8. An appliance as claimed in any one of the preceding claims, wherein said cathode (35) is manufactured from a gauze of stainless steel.

9. An appliance as claimed in any one of the preceding claims, wherein said anode (45) is manufactured from a flat graphite plate.

10. An appliance as claimed in claim 9, wherein said flat graphite plate is provided with openings.

11. An appliance as claimed in any one of the claims 1 to 8, wherein said anode (45) is manufactured from a titanium gauze provided with a platinum coating.

12. An appliance as claimed in any one of the preceding claims, wherein said anode (45) and said cathode (35) are connected to respective poles of a DC voltage source (65) designed for applying a constant voltage difference between said anode (45) and said cathode (35).

13. An appliance as claimed in claim 12, wherein the constant voltage difference lies in a range of between 35 and 42.5 volts.

14. An appliance as claimed in any one of the preceding claims, wherein said anode (45) is situated closely adjacent to said anion membrane (142).

15. An appliance as claimed in any one of the preceding claims, wherein said cathode (35) is situated closely adjacent to the kation membrane (32).

16. An appliance as claimed in any one of the claims 2 to 15, wherein a space between said anion membrane (142) and said kation membrane (32) is smaller than a space between said anode (45) and said anion membrane (142).

17. An appliance as claimed in any one of the claims 2 to 16, wherein a space between said anion membrane (142) and said kation membrane (32) is smaller than a space between said cathode (35) and said kation membrane (32).

18. An appliance as claimed in any one of the preceding claims, designed for a joint activation of the de-ionization means (405; 670) and the water-processing means (410; 620).
